(19) United States
(12) Patent Application Publication
(10) Pub. No.: US 2005/0253357 A1
(43) Pub. Date: Nov. 17, 2005

(54) Bicycle with suspension

(76) Inventors: Owen Chang, Dajia Town (TW); Hua-Chun Huang, Jhonghe City (TW)

Correspondence Address: VIERRA MAGEN MARCUS HARMON & DENIRO LLP, 685 MARKET STREET, SUITE 540, SAN FRANCISCO, CA, 94105, US

(21) Appl. No.: 11/207,259

(22) Filed: Aug. 18, 2005

(51) Int. Cl. B62K 25/00

(52) U.S. Cl. 280/283

(57) ABSTRACT

A bicycle frame apparatus is disclosed that includes a main frame, a sub-frame and a shock absorber. The sub-frame moves relative to the main frame. The shock absorber is positioned between the main frame and sub-frame so that the shock absorber effects movement of the sub-frame relative to the main frame. The main frame includes a down tube. The down tube includes an aperture. The shock absorber extends into and/or through the aperture to a connection point that, in some embodiments, is below the down tube.

### BACKGROUND

1. Field of the Invention

The technology described herein relates to bicycles.

2. Description of the Related Art

Mountain bikes are typically made to absorb bumps on the riding surface in order, for example, to accommodate riding off road. Many mountain bikes are equipped with a suspension system for the front wheel. For more extreme conditions, some mountain bikes are provided with suspension systems for the rear wheel.

As the sport of mountain biking has evolved, bigger obstacles and rougher terrain have become more common. As a result, bicycle manufacturers have attempted to increase the amount of distance that the rear wheel may move relative to the frame and to increase the performance of the rear suspension system. Some of the performance issues faced by designers of mountain bikes include limiting the power loss due to the operation of the rear suspension and limiting the influence of braking on the suspension system.

### SUMMARY

A bicycle frame apparatus is provided with an improved rear suspension system. The bicycle frame apparatus includes a main frame, a sub-frame and a shock absorber. The sub-frame moves relative to the main frame. The shock absorber is positioned between the main frame and sub-frame so that the shock absorber effects movement of the sub-frame relative to the main frame. The main frame includes a down tube.

In some embodiments, the down tube includes an aperture and the shock absorber extends through the aperture.

In some embodiments, the down tube is monolithic and is connected to a bottom bracket that is separate from the down tube. The down tube includes an aperture and the shock absorber extends into that aperture.

In some embodiments, the shock absorber is connected to the main frame at a connection location below the down tube.

### BRIEF DESCRIPTION OF THE DRAWINGS

FIG. 1 is a side view of a bicycle.

FIG. 2 is a side view of the bicycle frame depicted in FIG. 1.

FIG. 3 is a side prospective view of a portion of the bicycle frame depicted in FIG. 2, with a perspective taken from above the frame.

FIG. 4 is a side prospective view of a portion of the bicycle frame depicted in FIG. 2, with a perspective taken from below the frame.

FIG. 5 is side view of a bicycle.

FIG. 6 is a side view of the bicycle frame depicted in FIG. 5.

FIG. 7 is a side prospective view of a portion of the bicycle frame depicted in FIG. 6, with a perspective taken from below the frame.

FIG. 8 is a side prospective view of a portion of the bicycle frame depicted in FIG. 6, with a perspective taken from above the frame.

FIG. 9 is side view of a bicycle.

FIG. 10 is a side view is a portion of the bicycle depicted in FIG. 10.

FIG. 11 is a side prospective view of a portion of the bicycle depicted in FIG. 9, with a perspective taken from below the frame.

FIG. 12 is a side prospective view of a portion of the bicycle depicted in FIG. 9, with a perspective taken from above the frame.

FIG. 13 is a side prospective view of a portion of the bicycle depicted in FIG. 9.

FIG. 14 is side view of the bicycle depicted in FIGS. 9-13, with the rear wheel displaced based on movement facilitated by the rear suspension system.

FIG. 15 depicts a portion of a bicycle frame.

FIG. 16 depicts a bicycle.

FIG. 17 depicts a bicycle frame.

### DETAILED DESCRIPTION

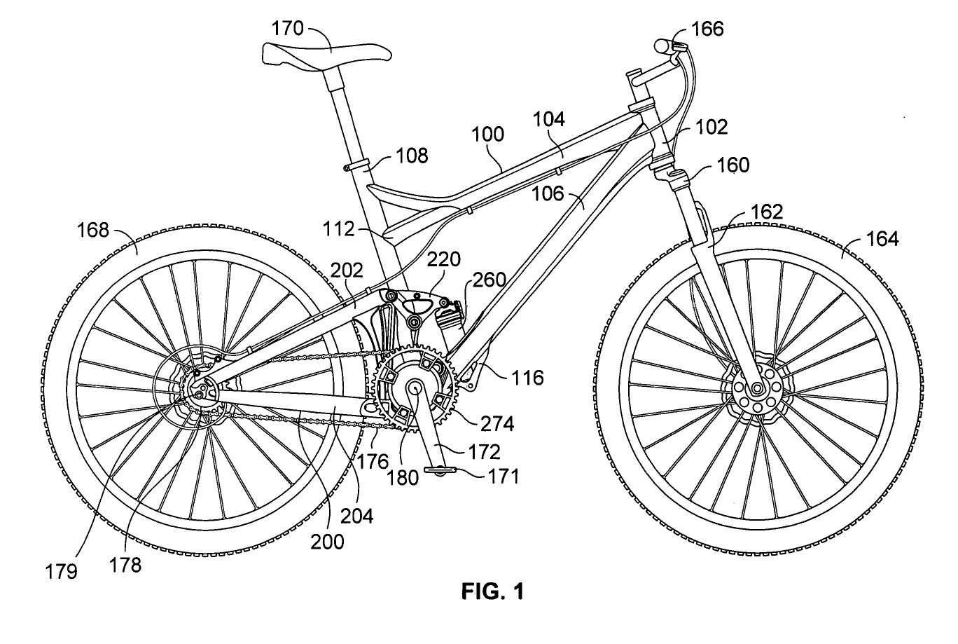

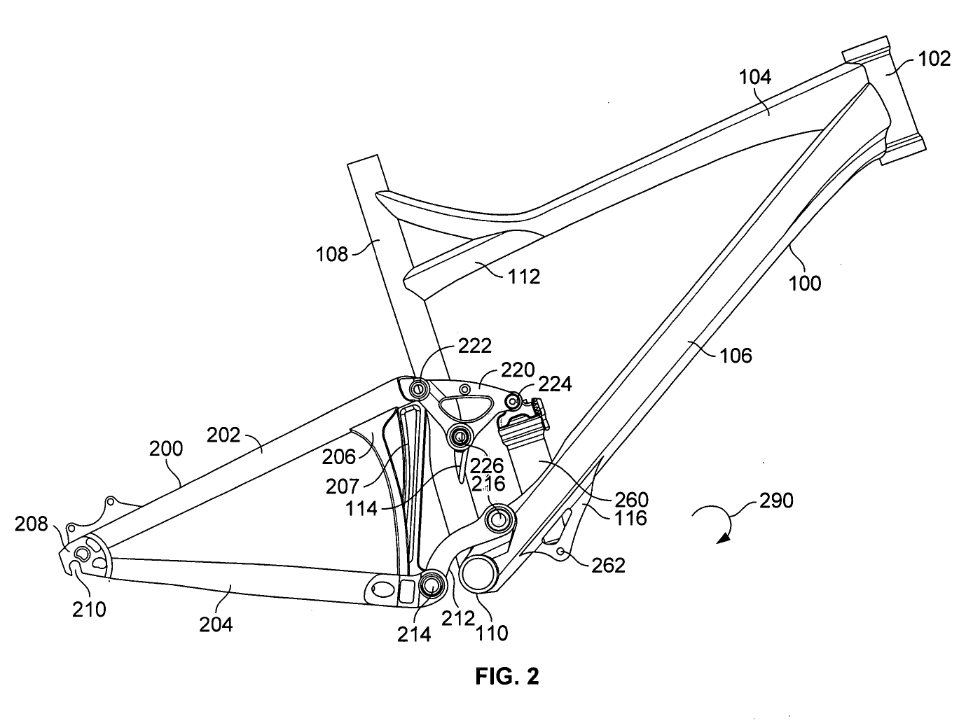

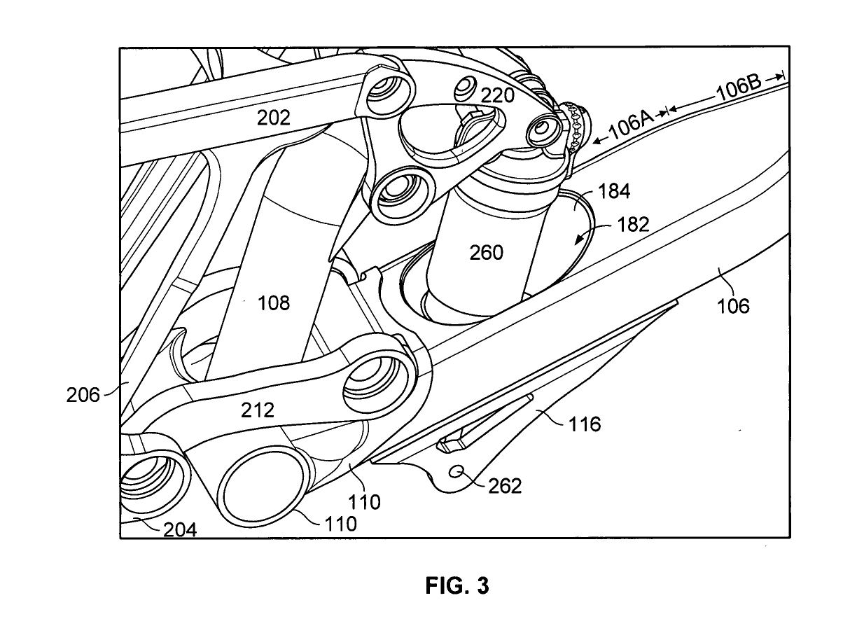

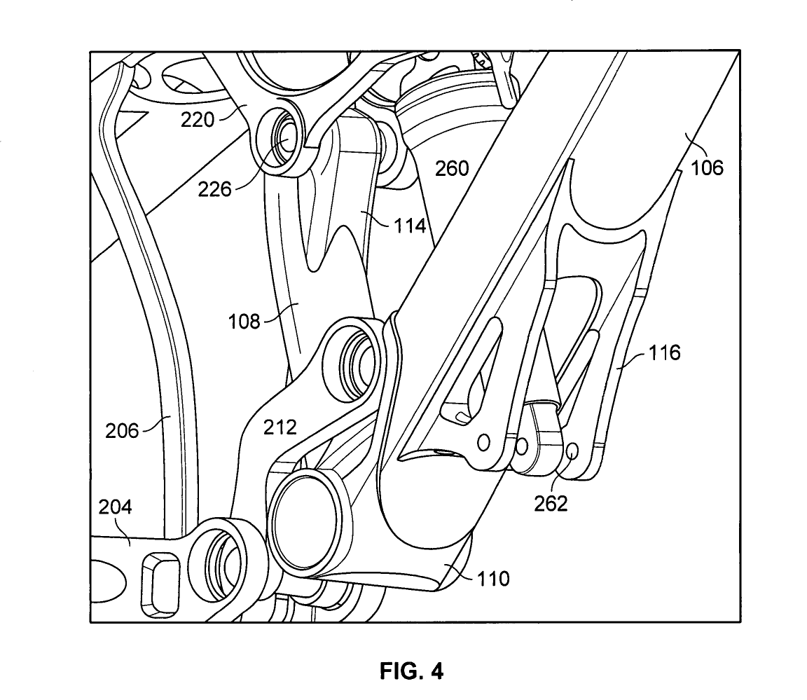

FIG. 1 is a side view of a bicycle. This bicycle can be used as a mountain bike (or other type of bicycle) to ride off-road or on roads. The bicycle in FIG. 1 is comprised of a frame that includes main frame 100 and sub-frame 200. The main frame can also be called a front triangle and the rear frame can also be called a rear triangle because both are generally in the shape of a triangle. FIG. 2 provides more details of the bicycle frame depicted in FIG. 1. FIGS. 3 and 4 are close up views that provide further details of portions of the bicycle frame. The discussion immediately below will make reference to the bicycle depicted in FIGS. 1-4.

Main frame 100 includes head tube 102, top tube 104 connected to head tube 102, down tube 106 connected to head tube 102, and seat tube 108 that receives seat 170. Seat 170 includes a saddle attached to a seat post that fits within seat tube 108. In some embodiments, down tube 106 is a monolithic component. In other embodiments, down tube 106 can be made of multiple components. Down tube 106 can have a cross section that is round, square, rectangular or another shape.

The rearward end of down tube 106 is connected to bottom bracket 110. The bottom of seat tube 108 is also connected to bottom bracket 110. Bottom bracket 110 can have many different shapes and sizes. Additionally, bottom bracket 110 can be a monolithic component or can be comprised of multiple components connected together. In some embodiments, bottom bracket 110 can be forged.

Near where top tube 104 and down tube 106 connect to head tube 102, the top of down tube 106 is in contact with the bottom of top tube 104. As depicted in FIGS. 1 and 2, a portion of the bottom of top tube 104 is cut away to facilitate contact with down tube 106. Main frame 100 also includes tubular member 112 which connects to top tube 104 and to seat tube 108. Top tube 104 curves upwardly between its connections with tubular member 112 and seat tube 108.

Main frame 100 also includes support member 114 and support member 116. Support member 116 is positioned at the bottom surface of down tube 106 and can be connected to the bottom surface of down tube 106 or a different surface of down tube 106. Support member 116 can be welded to down tube 106 or be integral with down tube 108. Support member 116 is welded to seat tube 108.

Sub-frame 200 (or rear triangle 200) includes two seat stays (a left seat stay and a right seat stay) on each side of the rear wheel, two chain stays (a left chain stay and right chain stay) on each side of the rear wheel and two linkage arms (a left linkage arm and a right linkage arm) on each side of the rear wheel. FIGS. 1 and 2 only show right seat stay 202 and right chain stay 204. Both seat stay 202 and chain stay 204 are rigidly connected (e.g., welded) to bracket 208. Bracket 208 includes opening 210 for receiving rear wheel 168. Right linkage arm 206 is rigidly connected to seat stay 202 and chain stay 204. Left linkage arm 207 is connected to the left side chain stay (not depicted) and left side seat stay (not depicted). Thus, in one embodiment, sub-frame 200 includes two triangles connected to each other. Each of the arms (e.g., chain stays, seat stays and linkage arms) forming the triangles are rigidly connected to each other.

Sub-frame 200 is connected to main frame 100 via link 212 and link 220. Link 212 connects to seat stay 204 at pivot connection point 214. Link 212 is connected to main frame 100 at pivot point 216 of bottom bracket 110. Link 220 has three pivot connections. Link 220 is connected to the front end of seat stay 202 at pivot connection 222, to support member 114 at pivot connection 226 and to shock absorber 260 at pivot connection 224. Motion of sub-frame 200 with respect to main fame 100 is at least partially defined by links 212 and 220.

The bicycle also includes a front wheel 164 and rear wheel 168 (see FIG. 1). Front wheel 164 is supported by fork 160 which is received in head tube 102. Fork 160 includes front suspension system 162 and is connected to handle bars 166. The bicycle also includes pedals 171 connected to crank 172. Crank 172 rotates about crank axis 180 and causes rotation of chain rings 274. In one embodiment, chain rings 274 include three chain rings of different diameters. In other embodiments, more or less than three chain rings can be used. Chain rings cause chain 176 to rotate which causes rear chain cogs 178 to rotate. Rotating rear chain cogs 178 causes rear wheel 168 to rotate. In some embodiments, a rear chain cogs 178 can include nine different gears. In other embodiments, more or less than nine gears can be used.

Shock absorber 260 passes into and through down tube 106 in order to protrude out of the bottom of down tube 106 in order to connect to pivot connection 262 of support 116. Pivot connection 262 is below down tube 106. In other embodiments, shock absorber 260 can be connected to the down tube or other device at other locations, including a location inside down tube 106.

More details of how shock absorber 260 passes through down tube 160 can be seen in FIGS. 3 and 4. Down tube 106 includes an aperture or opening 182. In some embodiments, the opening can be lined with sleeve 184. In some embodiments, sleeve 184 is a separate aluminum (or other material) component fixed within the aperture 182. In other embodiments, sleeve 184 can be integrally part of down tube 106. Aperture 182 is made big enough so that shock absorber 260 can pass through without touching the sides of sleeve 184, even as shock absorber 260 moves up and down or pivots.

The width of down tube 106 changes from a narrow width to a wider width. The narrow width is near the portion of down tube 106 closer to head tube 102. The wider width includes a portion of down tube 106 surrounding shock absorber 260. FIG. 3 shows section 106A of down tube 106 which pertains to the wider width and section 106B pertains to the transition region between the narrow width and the wider width. FIGS. 3 and 4 also provide a better view of bottom bracket 110 which includes an opening for housing crank 172.

When front wheel 164 encounters a bump on the riding surface, shock absorbing system 162 will compress to raise front wheel 162 in a directional along the axis of fork 160. If rear wheel 168 encounters a bump on the riding surface, rear wheel 168 will move in a near vertical direction. Link 220 will rotate about pivot point 226. Link 212 will also rotate so that both link 212 and 220 are rotating in a direction of curved arrow 290 (see FIG. 2). This will enable sub-frame 200 to move relative to main frame 100 so that rear wheel 168 is raised in a near vertical direction.

In one embodiment, the components of main frame 100 and sub-frame 200 are made of aluminum and are connected together using a welding process. In other embodiments, other means for connecting the components can also be used.

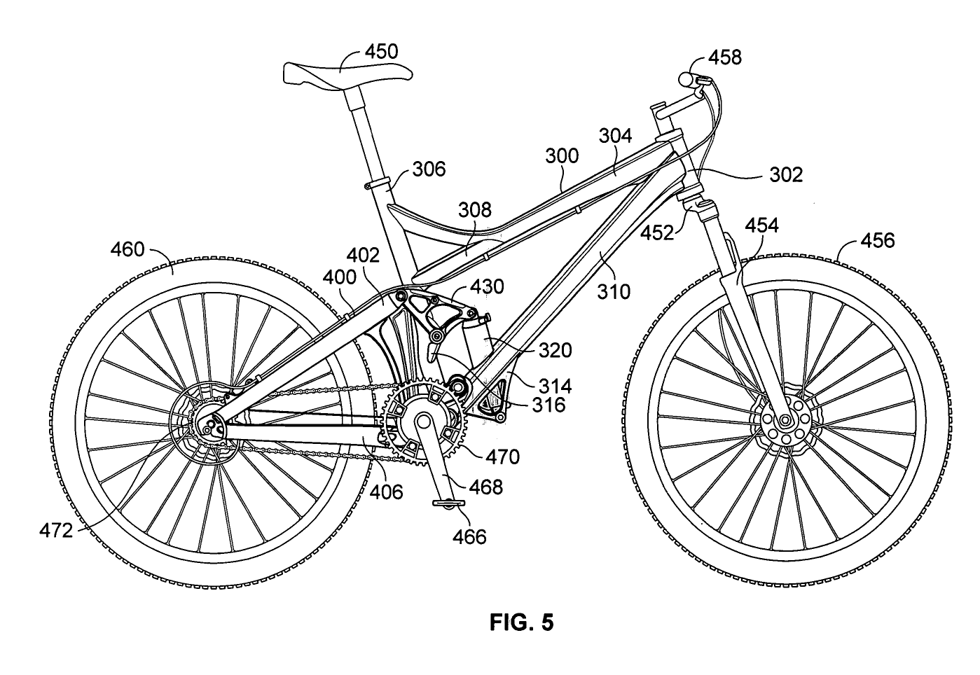

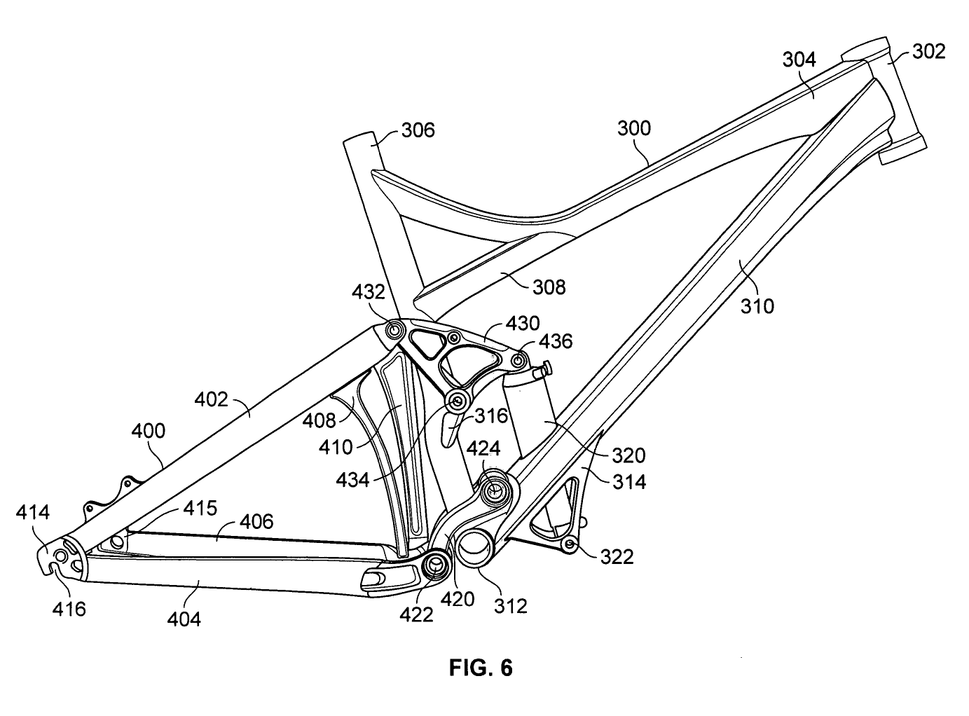

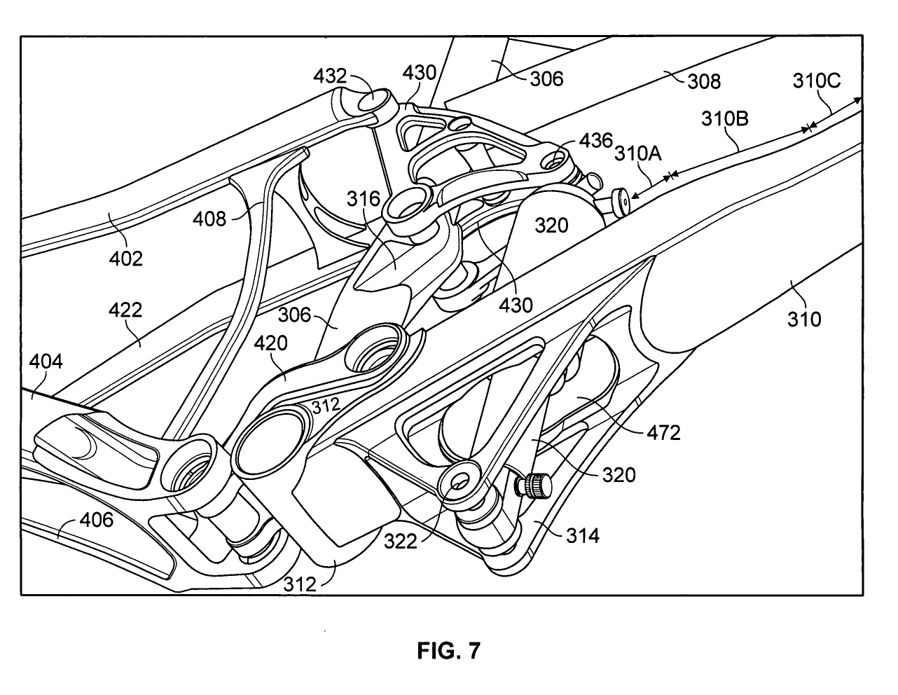

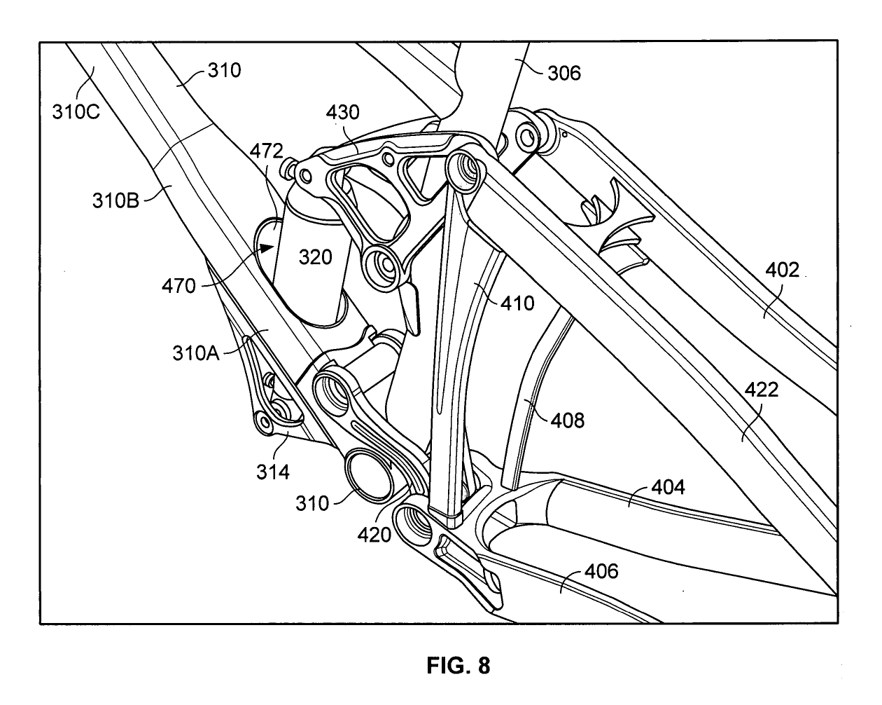

FIGS. 5, 6, 7, and 8 depict another embodiment of a bicycle that includes a frame comprising a main frame 300 and sub-frame 400. FIG. 5 is a side view of the entire bicycle. FIG. 6 is a close-up view of the bicycle frame. FIG. 7 is a close-up view of a portion of the bicycle frame in perspective from below the bicycle. FIG. 8 is a prospective view of a portion of the bicycle frame from above the bicycle.

Main frame 300 includes head tube 302, top tube 304 connected to head tube 302, and down tube 310 connected to head tube 302. Near head tube 302, the bottom of top tube 304 comes in contact with the top of down tube 310. A portion of the bottom surface of the front end of top tube 304 is cutaway to accommodate down tube 310. Top tube 304 also connects to seat tube 306. Connected in between seat tube 306 and top tube 304 is a tubular member 308. Between the connection with tubular member 308 and seat tube 306, top tube 304 curves up in a vertical direction.

The rearward portion of down tube 310 is connected to bottom bracket 312. The bottom of seat tube 306 is also connected to bottom bracket 312. Positioned at the bottom surface of down tube 310 is a support member 314. Support member 314 can also be connected to the bottom or other portions of down tube 310. In some embodiments, the connection between down tube 310 and support member 314 can be on a side or top surface of down tube 310, with the connection point between down tube 310 and shock absorber 320 being below down tube 310. Main frame 300 also includes support member 316 connected to seat tube 306. In one embodiment, the main frame 300 and sub-frame 400 are made of aluminum, with the various components are connected using a welding process.

Sub-frame 400 includes a set of seat stays, chain stays, and linkage arms to form two triangles (a left triangle and a right triangle). The left triangle includes one linkage arm, one seat stay and one chain stay rigidly connected to each other so that they can not pivot with respect to each other. In other embodiments, the components of sub-frame can pivot with respect to each other. The right triangle includes one linkage arm, one seat stay and one chain stay rigidly connected together. In other embodiment, the components of the right triangle can also pivot with respect to each other. FIG. 6 shows right seat stay 402, right chain stay 404 and right linkage arm 408. FIG. 8 shows left seat stay 422, left chain stay 406 and left linkage arm 410. The seat stays are connected to the chain stays via brackets 414 and 415. For example, seat stay 402 and chain stay 404 are both connected to bracket 414 which includes an opening 416 for receiving rear wheel 460.

Sub-frame 400 is connected to main frame 300 via a set of links 420 and 430 so that sub-frame 400 can move relative to main frame 300. Link 420 is connected to sub-frame 400 at pivot connection 422 of seat stay 404. Link 420 is connected to bottom bracket 312 of main frame 300 at pivot connection 424. Link 430 is connected to sub-frame 400 at pivot connection point 432 of seat stay 402. Link 430 is connected to support 316 of main frame 300 at pivot connection point 434. Link 430 is also connected to shock absorber 320 at pivot connection point 436. Shock absorber 320 passes into and through down tube 310 to connect to support 314 at pivot connection point 322.

FIG. 7 shows how down tube 310 widens near shock 320. For example, FIG. 7 shows wide width section 310A, transition section 310B, and narrow width section 310C of down tube 310. Within wider width section 310A is opening or aperture 470. In one embodiment, opening 470 is defined by sleeve 472, which can be an integral part of down tube 310 or a separate component welded or otherwise affixed to down tube 310. Support 314 can be an integral part of down tube 310 or a separate component welded to down tube 310. In either example, a monolithic (or multiple component) down tube connected to a bottom bracket can still have an opening for allowing shock absorber 320 to pass through that opening.

FIG. 5 shows the bicycle with the front wheel 456 received by shock system 452 of front fork 452. Head tube 302 receives fork 452 and connects to handlebars 458 for steering the bicycle. Rear wheel 460 is received in opening 416 of bracket 414. Pedal 466 is used to rotate crank 468 to cause chain rings 470 (one, two, or three chain rings) to rotate, which drives a chain to rotate cassette 472.

When front wheel 456 of the bicycle depicted in FIG. 5 encounters a bump, shock absorption system 454 will compress to absorb the shock. If rear wheel 460 encounters a bump in the riding surface, rear wheel 460 will move causing link 430 and link 420 to both rotate in a clockwise direction so that sub-frame 400 pivots in a manner that causes opening 416 of bracket 414 to be raised in near vertical direction. Sub-frame 400 will move about a set of floating pivot points, as discussed below.

Some of the differences between the bicycle of FIGS. 1-4 and the bicycle FIGS. 5-8 is that the bicycle of FIG. 1-4 is designed for 4 inches of rear wheel travel while the bicycle of FIGS. 5-8 is designed for 6 inches of rear wheel travel. That is, the rear suspension system of FIGS. 1-4 is designed to allow rear wheel 168 to be raised 4 inches in the vertical direction, while the rear suspension system of FIGS. 5-8 is designed to allow rear wheel 460 to be raised 6 inches in the vertical direction. Other differences between the bicycles include the shape and size of link 430 as compared to link 420. Link 430 is bigger than link 220 and includes a middle linkage arm. Link 430 also has an open trust configuration, while link 220 is in the shape of a triangle. Similarly, support 314 is wider than support 116, and has its shock connection point 322 lower than shock connection point 262 of support 116.

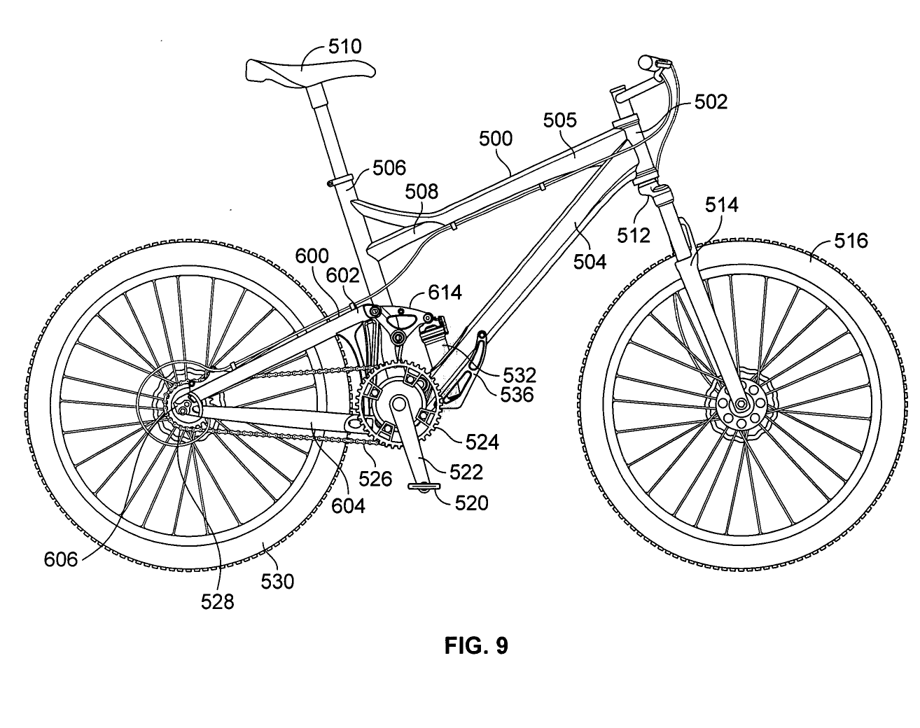

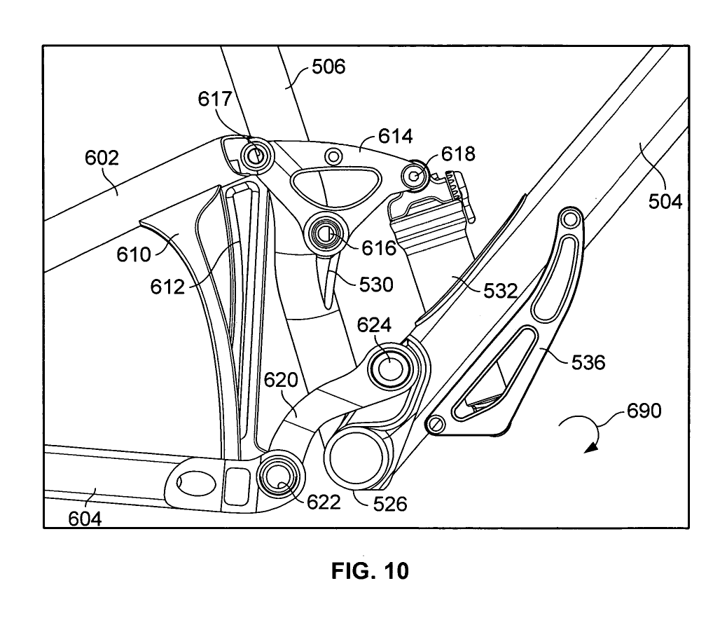

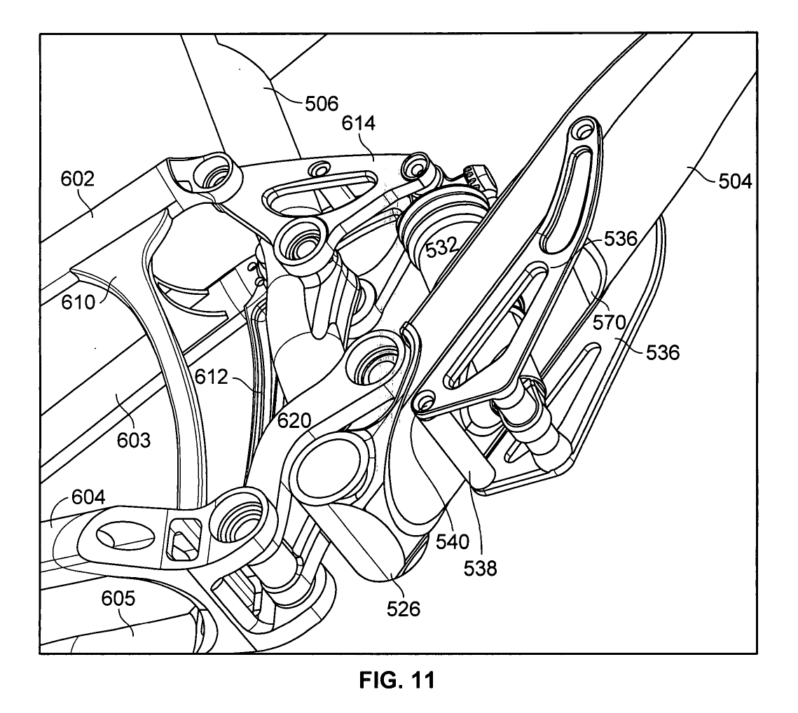

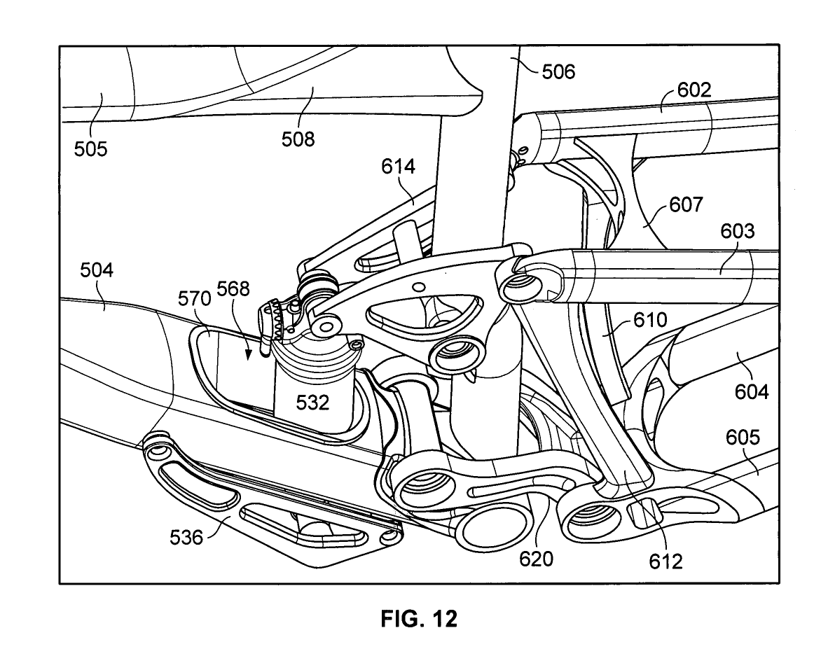

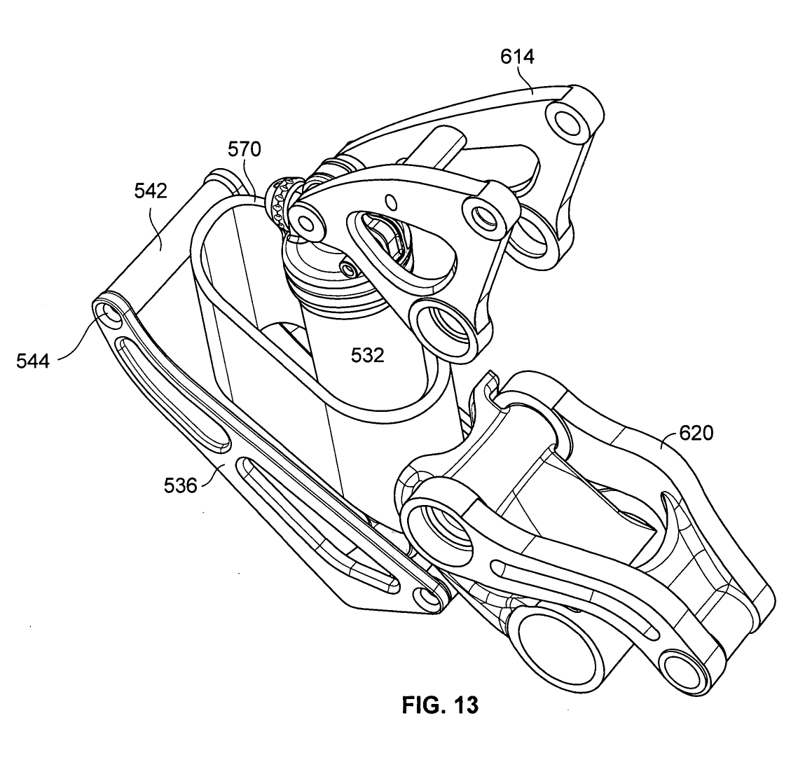

FIGS. 9-13 provide another embodiment of a bicycle. FIG. 9 is a side view of the entire bicycle. FIG. 10 is a close-up view of how the sub-frame connects to the main frame. FIG. 11 is another close-up view of how the sub-frame connects to the main frame in a prospective view from below the frame. FIG. 12 is another prospective view from above the bicycle. FIG. 13 is a close-up prospective view showing the positioning of the shock absorber.

The bicycle of FIGS. 9-13 includes a main frame 500 and sub-frame 600. Main frame 500 includes head tube 502, down tube 504 connected to head tube 502, and top tube 505 connected to head tube 502. Bottom bracket 526 is connected to the rearward end of down tube 504. Top tube 505 connects to seat tube 506. Connected between top tube 505 and seat tube 506 is a tubular member 508. Fork 512 is received in head tube 502. Fork 512 includes shock absorption system 514 which receives front wheel 516. Seat tube 506 receives seat (saddle and post) 510.

Sub-frame 600 includes right seat stay 602 and right chain stay 604, both rigidly connected to bracket 606. Bracket 606 includes an opening for receiving rear wheel 530. Sub-frame 600 also includes a left-side seat stay 603 and left-side chain stay 605, both connected to another bracket (not depicted). Right linkage member 610 that connects to seat stay 602 and chain stay 604. Left linkage member 612 connects to seat stay 603 and chain stay 605.

Sub-frame 600 is connected to and moves relative to main frame 500 in a motion at least partially defined by links 614 and 620. Link 614 is connected to sub-frame 600 at pivot connection point 617 and connected to support 530 of main frame 500 at pivot connection point 616. Support 530 is connected to seat tube 506. Link 614 is also connected to shock absorber 532 at pivot connection point 618. Link 620 is connected to sub-frame 600 at pivot connection point 622 and to bottom bracket 526 at pivot connection point 624. Shock absorber 532 is connected to support 536. The bottom of support 536 is connected to the bottom of down tube 504 and the top of support 536 is connected to the side surfaces of down tube 504. FIG. 11 shows tube 538, which is welded to down tube 504. A screw is then inserted through tube 538 and corresponding holes 540 in support 536 in order to attach support 536 to down tube 504. The screw is held in place using a nut.

Down tube 504 has a narrow width near head tube 502 and a wider width near bottom bracket 526, as depicted in FIG. 12. At the wider portion of down tube 504 is an opening 568 lined by sleeve 570. FIG. 13 is an exploded view which shows how shock absorber 532 passes through sleeve 570 and protrudes outside the bottom surface of down tube 504 to connect to support member 536 at a point below down tube 504. FIG. 13 also shows tube 542, which is welded to the inside of down tube 504. A screw is then inserted through tube 542 and corresponding holes 544 in support 536 in order to attach support 536 to down tube 504. The screw is held in place using a nut.

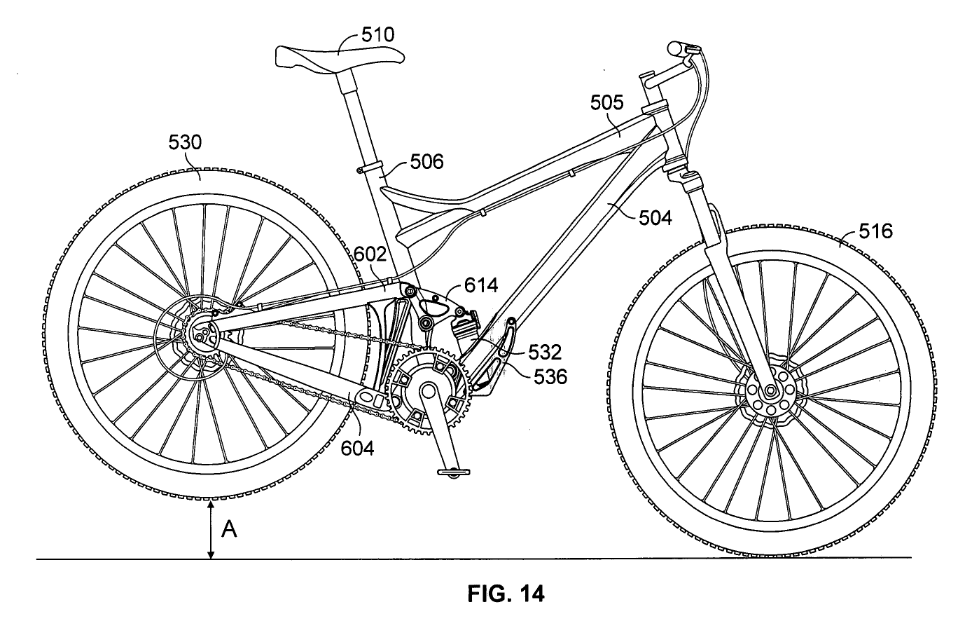

FIG. 14 shows the result of rear wheel 530 (the bicycle of FIGS. 9-13) encountering a bump in the riding surface. In response to the bump, rear wheel 530 travels in the near vertical direction (as depicted by arrow A) with respect to the main frame. This causes the sub-frame to pivot, as depicted in FIG. 14, with respect to the main frame. Link 614 and link 620 rotate in the same direction, as depicted by circular arrow 690 (see FIG. 10).

In some bicycles, when the rear wheel is displaced from the riding surface (and, therefore, moves with respect to the main frame), the rear wheel will pivot about a rear pivot point. If the pivot point is higher than the tangent line from the rear chain cogs to the chain rings, the chain force generated by pedaling can cause the shock absorber to extend. If the pivot point is lower than the tangent line from the rear chain cogs to the chain rings, the chain force generated by pedaling can cause the shock absorber to compress. This can condition can result in a loss of pedaling power.

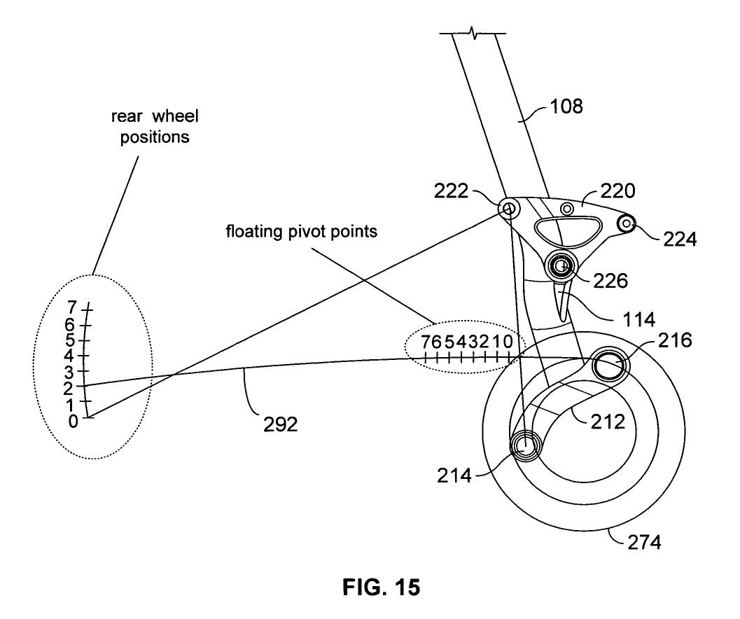

To overcome the above-described problem related to the loss of pedaling power, the bicycles described above utilize floating pivot points that are positioned on or very near the tangent line from the rear chain cogs to the middle chain ring. This concept is illustrated in FIG. 15, which references the bicycle of FIG. 1. Note that the concepts illustrated by FIG. 15 also apply to other embodiments in addition to the embodiments of FIG. 1. The concept of floating pivot points refers to the condition that the pivot point of the rear wheel will change as the rear wheel moves with respect to the main frame. FIG. 15 depicts floating points 0, 1, 2, 3, 4, 5, 6, and 7 along line 292. Line 292 approximates the position of chain 176, and is also an approximation of the tangent line connecting the rear chain cogs to the middle chain ring. The portion of line 292 closest to the chain rings is on or very close to that tangent line. Thus, floating points 0, 1, 2, 3, 4, 5, 6, and 7 lie on or very near the tangent line connecting rear chain cogs to the middle chain ring.

As the axle of the rear wheel (e.g. rear wheel 168) moves to the various wheel positions 0, 1, 2, 3, 4, 5, 6, and 7, the pivot point of rear wheel 168 (e.g., the pivot point of the axle 179 of rear wheel 168) will move to the corresponding pivot point of floating points 0, 1, 2, 3, 4, 5, 6, or 7. For example, if the axle of the rear wheel is at rear wheel position 6, then the rear wheel will appear to be pivoting about floating pivot point 6. Similarly, if the rear wheel axle is at rear wheel position 2, then t he rear wheel will appear to be pivoting about floating pivot point 2.

When the rear wheel is at its normal position on the riding surface (e.g., at position 0 of FIG. 15), the shock absorber compresses by approximately 1/4 to ⅓ of the maximum compression and the virtual pivot point is close to the junction between chain 176 and chain ring 274. Thus, any loss in pedaling energy is reduced. When the rear wheel moves upwardly away from the riding surface, the virtual pivot point moves rearwardly along line 292, as shown in FIG. 15, so as to reduce uncomfortable kickback of the pedals. The shock absorber is also tuned to resist small compressions or extensions due to movement of the chain to the inner or outer chain rings.

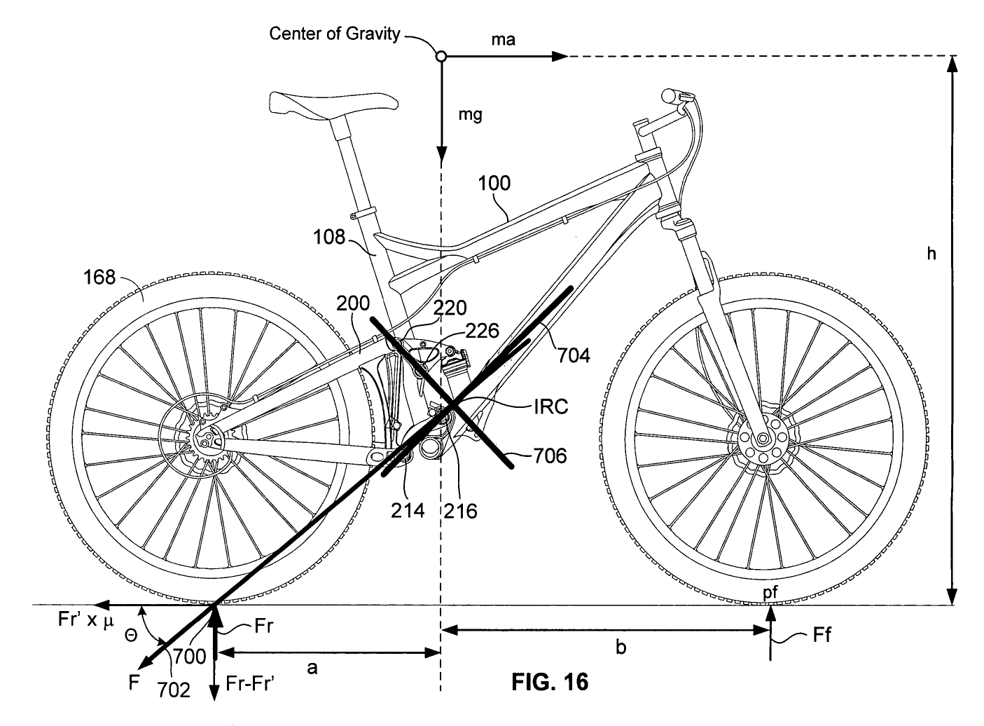

FIG. 16 depicts the bicycle of FIG. 1 in order to illustrate how braking effects the rear suspension system. The concepts of FIG. 16 also apply to other embodiments in addition to FIG. 1 When a rear brake (not shown) is actuated, a braking force F is applied to the rear wheel 168 at brake force location 700 along a force application line 702. The force application line 702 forms an angle θ with respect to a horizontal line. The angle θ is typically in the range of 40°-50°. In one embodiment, θ is 45°.

Sub-frame 200 has an Instantaneous Rotation Center IRC with respect to main frame 100. The IRC is located at an intersection of a first line 704 connecting pivot connection point 214 and pivot connection point 216 and a second line 706 connecting pivot connection point 220 and pivot connection point 226. Because force application line 702 intersects brake force location 700 and the IRC, the effect of the braking force F on the rear suspension system can be minimized. In this manner, the rear suspension is fully active during braking.

The following mathematics explains the above-described effect of the braking force F on the rear suspension system:
ma=inertial force when brake is applied;
mg=force of gravity;
Fr′=rear normal force;
Ff′=front normal force;
h=height of center of gravity;
μ=coefficient of friction;
wheel base=a+b;
ΣFx=0;
ma=Fr′×μ;
ΣMpf=0;
ma×h+Fr′×(a+b)=mg×b;
Fr′×μ×h+Fr′×(a+b)=mg×b;

$${Fr}^{′} = \frac{b}{a + b + μ \times h} mg ;$$

$$tan Θ = \frac{Fr - {Fr}^{′}}{{Fr}^{′} \times μ} ;$$

$$tan Θ = \frac{\frac{b}{a + b} \times mg - \frac{b}{a + b + μ \times h} \times mg}{\frac{b \times μ}{a + b + μ \times h} \times mg} ;$$

$$tan Θ = \frac{\frac{a + b + μ \times h - a - b}{( a + b ) \times ( a + b + μ \times h )}}{\frac{μ}{a + b + μ \times h}} ; and$$

$$tan Θ = \frac{h}{a + b} .$$

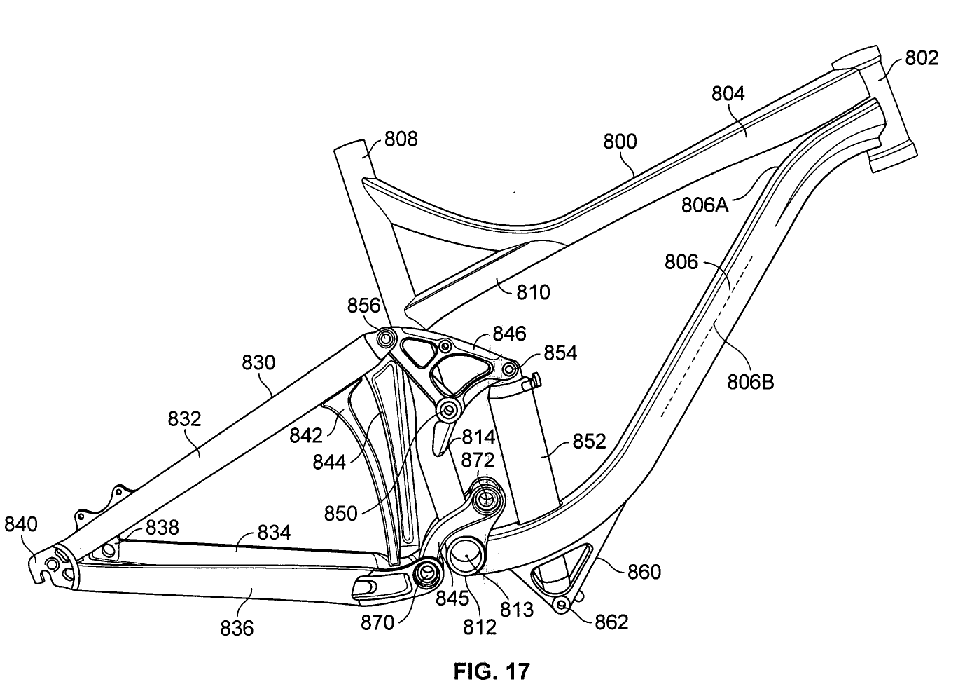

FIG. 17 provides embodiment of a bicycle frame that includes a main frame 800 and sub-frame 830. Main frame 800 includes head tube 802, top tube 804, down tube 806, bottom bracket 812, tube member 810, and seat tube 808. Bottom bracket 812 has an opening configured to the receive a pedal crank assembly for rotation about crank axis 813. Top tube 804 and down tube 806 are both connected to head tube 802. The top of down tube 806 is in contact with the bottom of top tube 804. In one embodiment, a portion of the bottom of top tube 804 is cut away to allow for a better fit with down tube 806. As depicted in FIG. 17, down tube 806 curves away from top tube 804 at section 806A. Down tube 806 then straightens out so that is has a down tube axis (see dashed line 806B). Note that down tube axis extends below crank axis 813 without intersecting crank axis 813. Near the rearward end of down tube 806, the down tube curves to meet and intersect bottom bracket 812. Support 860 is connected to the bottom of down tube 806. Support 814 is connected to seat tube 808.

Sub-frame 830 includes a pair of seat stays of which right seat stay 832 is depicted in FIG. 17. Sub-frame 830 also includes chain stays 834 and 836 connected to bracket 838 and 840, respectively, for receiving the rear wheel. Right linkage arm 842 connects to right seat stay 832 and to chain stay 836. Left linkage arm 844 connects to the left seat stay (not depicted) and to chain stay 834.

Sub-frame 830 is connected to and moves relative to main frame 800 via links 845 and 846. Link 846 is connected to sub-frame 830 at pivot connection point 856 and connected to support 814 at pivot connection point 850. Link 846 is also connected to shock absorber 852 at pivot connection point 854. Shock absorber 852 is connected to the main frame at pivot connection point 862 of support 860. Link 845 is connected to sub-frame 830 at pivot connection point 870 and to bottom bracket 812 at pivot connection point 872.

The foregoing detailed description has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

1. A bicycle frame apparatus, comprising:
a main frame;
a sub-frame; and
a shock absorber extending between said main frame and said sub-frame to facilitate said sub-frame moving relative to said main frame, said main frame includes a down tube, said down tube includes an aperture, said shock absorber extends through said aperture.

2. A bicycle frame apparatus according to claim 1, wherein:
said down tube includes a sleeve defining said aperture; and
said sleeve surrounds at least a portion of said shock absorber.

3. A bicycle frame apparatus according to claim 1, wherein:
said main frame includes a support member positioned on a bottom surface of said down tube; and
said shock absorber protrudes through said down tube and connects to said support member below said down tube.

4. A bicycle frame apparatus according to claim 1, wherein:
said down tube is monolithic.

5. A bicycle frame apparatus according to claim 1, wherein:
said down tube includes a first section, a second section and a transition section;
said first section is a first width;
said second section is a second width; and
said transition section provides a transition from said first width to said second width.

6. A bicycle frame apparatus according to claim 5, wherein:
said second section is rearward with respect to said first section; and
said second width is wider than said first width.

7. A bicycle frame apparatus according to claim 1, wherein:
said main frame includes a bottom bracket defining an opening configured to receive a pedal crank assembly for rotation about a crank axis;
said down tube has a down tube axis; and
said down tube axis is below said crank axis without intersecting said crank axis.

8. A bicycle frame apparatus according to claim 1, wherein:
said main frame includes a head tube, a top tube connected to said head tube and a seat tube;
said down tube is connected to said head tube; and
said down tube curves away from said head tube.

9. A bicycle frame apparatus according to claim 1, wherein:
said main frame includes a head tube, a top tube connected to said head tube and a seat tube connected to said top tube;
said down tube is connected to said head tube; and
a top of said down tube is in contact with a bottom of said head tube.

10. A bicycle frame apparatus according to claim 1, further comprising:
a front wheel;
a fork for receiving said front wheel, said fork is received by said main frame; and
a rear wheel received by said sub-frame.

11. A bicycle frame apparatus according to claim 1, wherein:
said sub-frame receives a rear wheel; and
said rear wheel moves relative to said main frame about floating pivot points.

12. A bicycle frame apparatus according to claim 11, wherein:
said sub-frame includes a first link and a second link;
said first link and said second link connect to said main frame; and
said first link and said second link allow for movement of said sub-frame relative to said main frame.

13. A bicycle frame apparatus according to claim 1, wherein:
said sub-frame includes a first link and a second link;
said first link is connect to said main frame; and
said second link is pivotally connected to said main frame and said shock absorber.

14. A bicycle frame apparatus according to claim 13, wherein:
said first link and said second link rotate in a same direction with movement of said sub-frame.

15. A bicycle frame apparatus according to claim 1, wherein:
said main frame includes a head tube and a top tube connected to said head tube;
said top tube curves away from said down tube.

16. A bicycle frame apparatus according to claim 1, wherein:
said sub-frame includes two chain stays, two seat stays and at least one linkage member between at least one of said chain stays and one of said seat stays.

17. A bicycle frame apparatus according to claim 1, wherein:
said sub-frame includes multiple members rigidly connected in a triangle orientation.

18. A bicycle frame apparatus, comprising:
a main frame;
a sub-frame movable relative to said main frame; and
a shock absorber extending between said main frame and said sub-frame, said main frame includes a monolithic down tube connected to a separate bottom bracket, said down tube includes an aperture, said shock absorber extends into said aperture.

19. A bicycle frame apparatus according to claim 18, further comprising:
a front wheel;
a fork for receiving said front wheel, said fork is received by said main frame; and
a rear wheel received by said sub-frame.

20. A bicycle frame apparatus according to claim 19, wherein:
said sub-frame includes a first link and a second link;
said first link is connect to said main frame;
said second link is pivotally connected to said main frame and said shock absorber;
said first link and said second link rotate in a same direction during movement of said sub-frame; and
said rear wheel moves about floating pivot points.

21. A bicycle frame apparatus according to claim 18, wherein:
said sub-frame includes multiple members rigidly connected in a triangle orientation.

22. A bicycle frame apparatus, comprising:
a main frame, said main frame includes a down tube;
a sub-frame movable relative to said main frame, said sub-frame configured to carry a rear wheel; and
a shock absorber connected to said sub-frame and said main frame, said shock absorber connected to said main frame at a connection location below said down tube.

23. A bicycle frame apparatus according to claim 22, further comprising:
a front wheel;
a fork for receiving said front wheel, said fork is received by said main frame; and
said rear wheel received by said sub-frame.

24. A bicycle frame apparatus according to claim 22, wherein:
said sub-frame includes a first link and a second link;
said first link is connect to said main frame;
said second link is pivotally connected to said main frame and said shock absorber;
said first link and said second link rotate in a same direction during movement of said sub-frame;
said rear wheel moves about floating pivot points.

25. A bicycle frame apparatus according to claim 23, wherein:
said sub-frame includes multiple members rigidly connected in a triangle orientation.

26. A bicycle frame apparatus according to claim 22, wherein:
said main frame includes a bottom bracket defining an opening configured to support a pedal crank assembly for rotation about a crank axis;
said down tube has a down tube axis; and
said down tube axis extends below said crank axis without intersecting said crank axis.

27. A bicycle frame apparatus according to claim 22, wherein:
said main frame includes a support member positioned on a bottom surface of said down tube; and
said shock absorber connects to said support member below said down tube.

28. A bicycle frame apparatus according to claim 22, wherein:
said down tube is monolithic.

29. A bicycle frame apparatus, comprising:
a main frame that includes a down tube and a support member positioned on a bottom surface of said down tube;
a sub-frame movable relative to said main frame, said sub-frame capable of receiving a rear wheel; and
a shock absorber connected to said sub-frame and said main frame, said shock absorber protrudes through said down tube and connects to said support member below said down tube.

30. A bicycle frame apparatus according to claim 29, wherein:
said down tube includes a first section, a second section and a transition section;
said first section is a first width;
said second section is a second width;
said transition section provides a transition from said first width to said second width;
said second section is rearward with respect to said first section; and
said second width is wider than said first width.

31. A bicycle frame apparatus according to claim 29, wherein:
said down tube is monolithic.

32. A bicycle frame apparatus according to claim 29, wherein:
said down tube and said support member are separate parts that are welded together.
